(19) United States
(12) Patent Application Publication
(10) Pub. No.: US 2019/0050881 A1
(43) Pub. Date: Feb. 14, 2019

(54) METHOD AND APPARATUS FOR REWARDING REACTION OF SIMULATION PARTICIPANT

(71) Applicant: MOTION DEVICE INC., Anyang-si (KR)

(72) Inventor: Jong Chan LEE, Anyang-si (KR)

(73) Assignee: MOTION DEVICE INC., Anyang-si (KR)

(21) Appl. No.: 15/827,698

(22) Filed: Nov. 30, 2017

(30) Foreign Application Priority Data
Aug. 9, 2017 (KR) 10-2017-0101318

(51) Int. Cl. G06Q 30/02; G06K 9/00; G10L 25/63

(52) U.S. Cl. CPC G06Q 30/0209; G10L 25/63; G06K 9/00302; G06Q 30/0236

(57) ABSTRACT

Disclosed are a method and apparatus for rewarding a simulation participant for a reaction, in which the apparatus is arranged around a simulator and gives a reward for reactions of spectators and a participant who controls the simulator according to the reactions. To this end, a method of rewarding a simulation participant taking part in a simulation implemented by a simulator for a reaction includes: collecting at least one of video information and audio information of a participant while the participant takes part in a simulation from at least one of a camera and a microphone; detecting at least one reaction of the participant from the collected at least one of the video information and the audio information; determining a reaction level of the detected reaction; and giving a reward for the reaction to the participant when the determined reaction level is a certain value or more.

### CROSS-REFERENCE TO RELATED APPLICATION

This application claims priority to and the benefit of Korean Patent Application No. 10-2017-0101318, filed on Aug. 9, 2017, the disclosure of which is incorporated herein by reference in its entirety.

### BACKGROUND

### 1. Field of the Invention

The present disclosure relates to a method and apparatus for rewarding reaction of a simulation participant, and more particularly to a method and apparatus for rewarding reaction of a simulation participant, in which the apparatus is arranged around a simulator, senses reactions of spectators and a participant who controls the simulator, and gives a reward for the sensed reactions.

### 2. Discussion of Related Art

A simulator (in particular, a motion simulator) refers to an apparatus that reproduces dynamic variations in accordance with virtual environments controlled by a computer, and makes a participant feel motion in virtual reality as reality. The simulator may include a simulation screen, a control lever, and a chair on which a participant who moves two-dimensionally or three-dimensionally. Further, the simulator includes elements for rotational and rectilinear motions of the simulator, and is thus movable by combining rectilinear motion in forward and backward directions (Z axis), leftward and rightward directions (X axis), and upward and downward directions (Y axis), and rotational motion with rolling around the Z axis, pitching around the X axis, and yawing around the Y axis. Therefore, the simulator moves under control of the participant when the participant controls the control lever in the simulator, thereby increasing the participant's immersion in a simulation that operates through the simulator.

With these features, the simulator has been applied to flight simulation, driving simulation, or the like, and has recently been widely utilized as a simulator for a game, a movie theater, and the like to give a 3D experience.

Sales of businesses utilizing such simulators are greatly affected by a field atmosphere. Conventionally, a method of recruiting service providing personnel for assisting in the use of the simulator and making the recruited service providing personnel attract the attention of surrounding spectators and say various lines to liven up the field atmosphere has been used. However, employment costs of such assistant personnel are relatively higher than the sales, general temporary part-time personnel have limitations in attracting the attention of the surrounding spectators, and it is also difficult for skilled personnel to continuously provide high quality service.

In addition, a participant of a game simulator has conventionally been rewarded for good game skills or frequent visits to the simulation. That is, a participant who has good game skills is, for example, able to get game items, and a participant who frequently visits a game simulator is, for example, able to receive a discount coupon corresponding to the number of visits from a simulator system operator. However, these rewards are only for rewarding the participant directly concerned with the simulation rather than attracting the attention of the surrounding spectators.

Accordingly, a new method is needed to increase the immersion and interest of spectators as well as a participant in the simulation and considerably reduce costs of improving a field atmosphere.

### SUMMARY OF THE INVENTION

The present disclosure is directed to a method and apparatus for rewarding reaction of a simulation participant, which can liven up a simulation-field atmosphere without skilled personnel, increase immersion of a participant and a spectator in a simulation, or maximize participation in the simulation.

According to an aspect of the present disclosure, there is provided a method of rewarding a simulation participant taking part in a simulation implemented by a simulator for a reaction, the method including: collecting at least one of video information and audio information of a participant while the participant takes part in a simulation from at least one of a camera and a microphone; detecting one or more reactions of the participant from the collected at least one of the video information and the audio information; determining a reaction level of the detected reaction; and giving a reward for the reaction to the participant when the determined reaction level is a certain value or more.

The reaction may include at least one of sound being made, a change in voice loudness, a change in facial expression, and a change in gesture of the participant.

The detecting of the one or more reactions may be performed at one or more preset points of time at which a reaction of the participant is expected during the simulation.

The determining of the reaction level may include determining a reaction level based on different criteria according to a type of each of the reactions.

The determining of the reaction level may be performed by determining a reaction level value of one among types of reactions, or summing reaction level values with different weights according to a type of the reaction with regard to the plurality of types of reactions.

A highest weight may be given to a change in voice loudness of the participant among the types of reactions.

The determining of the reaction level may be performed by summing reaction level values detected at one or more preset points of time in the simulation.

The determining of the reaction level may be performed by summing only reaction level values higher than or equal to thresholds set for the type of each of the reactions.

The determining of the reaction level may be performed in consideration of reaction levels of one or more spectators.

The reaction level of the spectator may be determined by a first sum obtained by summing reaction levels of the spectators; a second sum obtained by summing at least one reaction level value of an entire group of spectators such as a change in the number of spectators or a change in voice loudness of the entire group of spectators; or a sum obtained by combining the first sum and the second sum.

The reward may include at least one among a point, a free gift, a voucher, a free coupon, a discount coupon, and a mileage point.

The giving of the reward may include giving the reward for the reaction differentially for each reaction level.

The method may further include identifying the simulation participant.

The method may further include checking whether a participant whose determined reaction level is the certain value or more is registered as a member; and generating a membership application screen to induce the participant to apply for membership when the participant is not registered as the member, wherein the membership application screen includes an information input area for receiving an ID and a phone number of the participant.

In the method, the collecting may be performed in a field terminal at a field where the simulator is placed, the detecting, the determining of the level, and the giving of the reward may be performed in a server, and the field terminal and the server may be configured to communicate with each other.

According to one embodiment of the present disclosure, there is provided an apparatus for rewarding a simulation participant taking part in a simulation implemented by a simulator for a reaction, the apparatus including: an information collector configured to collect at least one of video information and audio information of a participant while the participant takes part in a simulation by using at least one of a camera and a microphone; a reaction level determiner configured to detect at least one reaction of the participant from the collected at least one of the video information and the audio information, and determine a reaction level of the detected reaction; and a reward determiner configured to give a reward for the reaction to the participant when the determined reaction level is a certain value or more, wherein the apparatus is configured to perform operations of the above method.

The reward may include at least one among a point, a free gift, a voucher, a free coupon, a discount coupon, and a mileage point.

The reward determiner may give the reward for the reaction differentially according to the reaction level thereof.

The apparatus may further include an identifier configured to identify the simulation participant.

The apparatus may further include a membership manager configured to check whether a participant whose determined reaction level is the certain value or more is registered as a member, and generate a membership application screen to induce the participant to apply for membership when the participant is not registered as the member, wherein the membership application screen includes an information input area for receiving an ID and a phone number of the participant.

The apparatus may include an intelligent robot, and the intelligent robot may receive information from a camera or a microphone located inside or around the simulator or from a camera or a microphone mounted to one side of the intelligent robot.

According to one embodiment of the present disclosure, there is provided a server for rewarding a simulation participant taking part in a simulation implemented by a simulator for a reaction, the server including: a server communicator configured to receive at least one of video information and audio information of a participant while the participant takes part in a simulation from a field terminal at a field at which the simulator is located; a reaction level determiner configured to detect at least one reaction of the participant from the received at least one of the video information and the audio information, and determine a reaction level of the detected reaction; and a reward determiner configured to give a reward for the reaction to the participant when the determined reaction level is a certain value or more.

According to one embodiment of the present disclosure, there is provided a method of rewarding a simulation participant taking part in a simulation implemented by a simulator for a reaction, wherein the method is performed in a reaction reward server, and the method includes: receiving at least one of video information and audio information of a participant while the participant takes part in a simulation from a field terminal at a field at which the simulator is located; detecting at least one reaction of the participant from the received at least one of the video information and the audio information; determining a reaction level of the detected reaction; and giving a reward for the reaction to the participant when the determined reaction level is a certain value or more.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an apparatus for rewarding a simulator participant for a reaction according to a first embodiment of the present disclosure;

FIG. 2 is a view of illustrating an example of a message received from the apparatus for rewarding a simulator participant for a reaction according to the first embodiment of the present disclosure;

FIG. 3 is a conceptual view of a simulator participant reaction rewarding system according to a second embodiment of the present disclosure;

FIG. 4 is a block diagram of a field terminal according to the second embodiment of the present disclosure;

FIG. 5 is a block diagram of a reaction reward server according to the second embodiment of the present disclosure;

FIG. 6 is a flowchart of a method of rewarding a simulator participant for a reaction according to the first embodiment of the present disclosure; and

FIG. 7 is a flowchart of a method of operating a reaction reward server of a simulator participant according to the second embodiment of the present disclosure.

### DETAILED DESCRIPTION OF EXEMPLARY EMBODIMENTS

Exemplary embodiments of the present disclosure will be described in detail below with reference to the accompanying drawings. Here, repetitive descriptions, and detailed descriptions about well-known functions and features which may unnecessarily obscure the gist of the present disclosure will be omitted. The embodiments of the present disclosure are provided to make a person having ordinary skill in the art more thoroughly understand the present inventive concept. Thus, the shape, size, and the like of the elements shown in the drawings may be exaggerated for more explicit descriptions.

Below, a method and apparatus for rewarding a simulation participant for a reaction will be described according to embodiments of the present disclosure. In the following description, a simulator may include a simulation screen, a chair on which a participant who moves two-dimensionally or three-dimensionally sits, and a control lever or an optional simulation auxiliary device that the participant carries or wears. Here, the simulation auxiliary device may be free have any size, and may be a small device such as a smart phone.

In addition, a simulation may be a kind of program to be executed through the simulator, and may include mock entertainment for inducing a participant to have a reaction, for instance, a simulation game (e.g., flying, driving a vehicle, and the like). Further, the simulation may be an educational training program.

As described above, a business utilizing a simulator is directly related to an interest in the simulator, and such interest varies largely depending on a field atmosphere. Further, the field atmosphere may be significantly affected by a reaction of a simulator participant. Thus, a reaction rewarding apparatus according to an embodiment of the present disclosure is characterized in that it takes a reaction into account to liven up a field atmosphere at which the simulator is installed.

Specifically, the reaction rewarding apparatus according to the embodiment of the present disclosure may detect a reaction of a simulation participant, determine a reaction level, and give a reward (e.g., a point, a present (or a free gift), a voucher, a coupon (e.g., a free coupon or a discount coupon), and a mileage point) to a person who has a positive effect on the field atmosphere.

Of course, the concept of giving a reward is common. However, the conventional concept of giving a reward is generally based on a purpose of merely promoting a simulator to a person who is good at a simulation or a game. For example, a conventional reward is restrictively given to a certain user who wins an event or visits a game more than a specific number of times when the user achieves a ranking place in the game (e.g., a score, a rank, a simulation using a skill, and the like).

On the other hand, according to the embodiments of the present disclosure, a specific person who has an effect on a field atmosphere is chosen, and the chosen person is rewarded. That is, embodiments of the present disclosure differ in a purpose of giving a reward from the foregoing conventional concept. Therefore, the embodiments of the present disclosure analyzes how great of an effect a corresponding participant has on a field atmosphere and gives a reward to the participant in accordance with the effect, regardless of how good the participant is at a simulation and how frequently he or she uses the simulation.

Further, according to the present disclosure, immersion in a simulation or achievement of an educational goal may be evaluated on the basis of a reaction level of a simulation participant, and an evaluation result may be used as basic data when a simulation program is upgraded (or updated) in the future. Further, this basic data may be used in the future when a simulation service provider provides a variety of different services or artificial intelligent services, thereby diversifying the services.

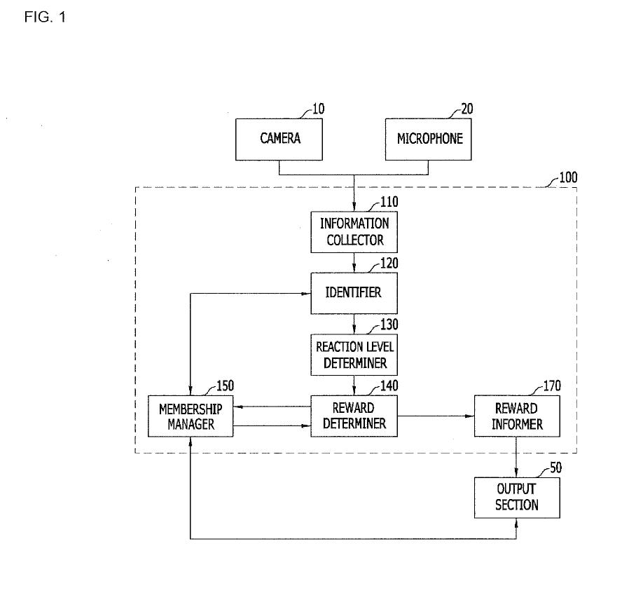

FIG. 1 is a block diagram of a reaction rewarding apparatus 100 according to a first embodiment of the present disclosure. Here, the first embodiment of the present disclosure shows that the reaction rewarding apparatus 100 is provided as an apparatus located in a field and performs the following functions. The reaction rewarding apparatus 100 according to the first embodiment of the present disclosure may be configured to include an information collector 110, an identifier 120, a reaction level determiner 130, a reward determiner 140, a membership manager 150, and a reward informer 170. Here, these elements are functionally divided to help understanding of the present disclosure, but may be practically implemented by a central processing unit (CPU), a graphic processing unit (GPU), a microprocessor unit (MPU), or the like as a single processing unit.

The information collector 110 functions to receive information from a camera 10 or a microphone 20. Specifically, the information collector 110 serves to collect a plurality of pieces of video information (e.g., a still image or a moving image) captured by the camera 10, and audio information sensed by the microphone 20. There may be a plurality of cameras 10. For example, at least one of the cameras may be installed inside a simulator in a direction facing a participant and take an image of the participant, and the other cameras may be positioned around the simulator or on a ceiling or the like and record spectators. Of course, to sense spectators who are gathered together, the camera may be positioned to record both the simulator and a surrounding area. The captured video information and the sensed audio information may be collected in the information collector 110 being directly connected with the reaction rewarding apparatus 100 or through wired or wireless communication. In addition, the foregoing terms “camera” include any device as long as the device can image an object. That is, the camera may include a sensor in addition to a common camera, a depth camera, a wide-angle camera (e.g., a camera with a wide-angle lens or a fish-eye lens), and the like. Further, the camera should to be construed as an image sensor configured to apply an imaging process to a captured image.

The identifier 120 serves to identify a participant and a spectator by analyzing the plurality of pieces of video information and audio information. Specifically, for example, the identifier 120 may classify the video information captured by the camera located inside the simulator as that of the participant, and classify the video information captured by the camera located outside the simulator as that of the spectator.

The identifier 120 may further determine whether the participant and the spectator identified through the identifier 120 are registered members by analyzing the video information. For example, the identifier 120 identifies the faces of the participant and the spectator from the plurality of pieces of video information, and compares the identified faces with face information of members stored in a storage (not shown) to determine whether the participant and the spectator are the registered members. Here, in a business using a simulator, whether a general spectator is a registered as a member is not very important, but guiding the participant to sign up to be a member is preferable since the participant is interested in the simulator. Thus, when the participant is not a registered member of the simulator, the identifier 120 may perform a process of inducing the participant to apply to be a member through association with the membership manager 150, which will be described later. Of course, the process of guiding a participant to sign up for a membership is optional and not essential in the present disclosure.

The reaction level determiner 130 detects at least one reaction of the participant, and determines a reaction level of the detected reaction. The term “reaction” used throughout this specification refers to any body-reaction of a participant in response to a simulation, and, for example, includes behaviors, such as a sound, such as a speaking voice, a scream, and an exclamation, being made, a change in voice loudness, a change in facial expression, a change in a gesture, and the like, that can be immediately observed by others. The reaction level determiner 130 may determine the level of the reaction by using different criteria according to the reaction levels.

For example, the reaction level determiner 130 may use different criteria according to a kind of sound made by a person, for example, a speaking voice, a scream, and an exclamation, to determine the reaction level, and, in case of the exclamation, may give a higher reaction level to a more stimulating exclamation. Likewise, the reaction level determiner 130 may give a lower reaction level to a facial expression changing slightly into a smile or a small gesture, but may give a higher reaction level to a facial expression significantly changing into a look of surprise, or clapping or a surprised gesture.

To this end, the reaction level determiner 130 may use a preset face detecting algorithm (or expression detecting algorithm), a preset gesture detecting algorithm and the like to detect a facial expression and gesture of the participant. Here, the face detecting algorithm may, for example, employ an algorithm based on intensity of an image, a geometric method, a neural network, adaptive boosting (Adaboost), a support vector machine, and the like.

First, the face detecting algorithm using intensity of an image refers to a method of finding light and darkness caused by a shadow generated around eyes, a nose, lips, and a jaw in a still image or a moving image since a face is three-dimensional (3D), and recognizing the face on the basis of the light and the darkness.

The face detecting algorithm using the geometric method refers to a method of extracting a plurality of feature points from a still image or a moving image, and detecting a face through a comparison between the extracted feature points and preset facial geometric feature points. That is, by comparing the extracted feature points with the preset facial geometric feature points, the face of each individual person can be recognized within a still image or a moving image, and components of the face (i.e., eyes, a nose, lips, cheeks, cheekbones, and the like) can be recognized.

The neural network-based algorithm refers to a statistical learning algorithm inspired by a neural network (e.g., a brain) in biology, and refers to all models having a problem solving ability by changing strength of connection between synapses via artificial neurons, which form the network with the connection of the synapses, learning.

The Adaboost-based algorithm refers to a method of performing mechanical learning by selecting only features expected to improve estimation ability of a model.

In addition, the support vector machine-based algorithm refers to a map learning model for recognizing a pattern and analyzing data as one of mechanical learning fields, and is generally used for classification and regression analysis. When a set of data that belongs to one of two categories is given, the support vector machine algorithm generates a non-stochastic binary linear classification model for determining what category new data will belong to on the basis of the given set of data. The generated classification model is represented as a boundary in a data mapping space, in which the support vector machine-based algorithm is an algorithm for finding the widest boundary among boundaries.

Here, the facial recognition algorithm using the neural network, the Adaboost, or the support vector machine may be variously modified and applied for use, and therefore is not limited to a specific method in the present disclosure. Further, these algorithms are known well in various fields, and therefore additional descriptions thereof will be omitted.

Accordingly, the reaction level determiner 130 may recognize a face of a person through at least one algorithm among various facial recognition algorithms described above. After facial recognition, the reaction level determiner 130 further analyzes the recognized face to further determine a facial expression made by the corresponding person. Specifically, the reaction level determiner 130 may determine what facial expression (e.g., an impassive expression, a smiling expression, a crying face, a surprised expression, and the like) the recognized person (i.e., the participant and the spectator) made, and determine how strong the expression is.

For example, in case in which a person laughs, someone may smile, but someone else may laugh out loud. Likewise, someone may make a slightly surprised expression, but someone else may make a greatly surprised expression. Like this, even when persons make the same kind of facial expression, the persons may be different in the strength of the facial expression. Therefore, the reaction level determiner 130 may determine whether the participant and the spectators make a facial expression and determine the strength of each facial expression.

After determining the facial expressions and their strength for each of the participant and the spectators, the reaction level determiner 130 may, for example, assign reaction levels based on the strength to the expressions, as shown in Table 1 below.

TABLE 1

| | Weak level | | | Moderate level | | | | Strong level | | |
|---|---|---|---|---|---|---|---|---|---|---|
| Smiling expression | 1 | 2 | 3 | 4 | 5 | 6 | 7 | 8 | 9 | 10 |
| Surprised expression | 1 | 2 | 3 | 4 | 5 | 6 | 7 | 8 | 9 | 10 |

In Table 1, the weak level is close to an impassive expression, and the strong level is close to a laughing-out-loud expression or greatly-surprised expression. Table 1 shows that a value of a reaction level varies depending on the strength of the expression regardless of the kind of expression, but this variance is only for the purpose of illustration. Practically, the reaction level may be assigned according to a kind of an expression. For example, reaction levels for the smiling expression may be set to range from 1 to 10, and reaction levels for the surprised expression may be set to range from 5 to 14. That is, the reaction levels may be differently assigned according to a kind and strength of a detected expression. In addition, kinds of facial expression may also include various other facial expressions besides the above two facial expressions, and values and numbers of the reaction levels may be variously modified.

The reaction level determiner 130 may detect a gesture of each individual person through a gesture detecting algorithm such as an algorithm using coordinates centered on joint points, a K-nearest neighbor (KNN) algorithm, and the like. For example, the reaction level determiner 130 sets feature points on a neck, a shoulder, a waist, an elbow, a knee, an ankle, and the like through the gesture detecting algorithm using coordinates centered on joint points, detects a gesture of a person based on connection lines between the feature points and an angle between the connection lines, and compares the detected gesture with a gesture previously learned through the KNN algorithm to determine a kind of the gesture.

In addition, like the facial expression process, the reaction level determiner 130 may further determine gesture strength of the participant and the spectator through the gesture detecting algorithm. For example, the reaction level determiner 130 may determine a clapping gesture, a surprised gesture, and the like of a person along with strength of the gesture.

After determining the gesture and the strength of the gesture for each of the participant and the spectators, the reaction level determiner 130 may assign a reaction level based on the strength to the gesture, as shown in Table 2 below.

TABLE 2

| | Weak level | | | Moderate level | | | | Strong level | | |
|---|---|---|---|---|---|---|---|---|---|---|
| Clapping | 1 | 2 | 3 | 4 | 5 | 6 | 7 | 8 | 9 | 10 |
| gesture | | | | | | | | | | |
| Surprised | 1 | 2 | 3 | 4 | 5 | 6 | 7 | 8 | 9 | 10 |
| gesture | | | | | | | | | | |

In Table 2, the weaker level is close to an inflexible posture, and the stronger level shows wider clapping or surprised gestures. Table 2 shows that a value of a reaction level varies depending on the strength of gesture regardless of the kind of gesture, but this variance is only for the purpose of illustration. Practically, the reaction level may be assigned according to a kind of a gesture (e.g., the reaction level may be assigned to be higher for a clapping gesture than a surprised gesture, or vice versa). In addition, kinds of gesture may include various other gestures besides the above two gestures, and values and numbers of the reaction levels may be variously modified.

Likewise, the reaction level determiner 130 may further determine a kind of sound and the level of the sound while detecting the sound, and assign reaction levels thereto on the basis of the kind and level to the sound for each of the participant and the spectators, as shown in Table 3 below.

TABLE 3

| | Weak level | | | Moderate level | | | | Strong level | | |
|---|---|---|---|---|---|---|---|---|---|---|
| Laughter | 1 | 2 | 3 | 4 | 5 | 6 | 7 | 8 | 9 | 10 |
| Speaking | 1 | 2 | 3 | 4 | 5 | 6 | 7 | 8 | 9 | 10 |
| Voice | | | | | | | | | | |
| Exclamation | 1 | 2 | 3 | 4 | 5 | 6 | 7 | 8 | 9 | 10 |
| Scream | 1 | 2 | 3 | 4 | 5 | 6 | 7 | 8 | 9 | 10 |

Table 3 shows that a value of the reaction levels assigned to the sounds vary depending on the level regardless of the kind of sound, but this variance is only for the purpose of illustration. Alternatively, the reaction levels may be assigned differently according to the kind of sound, as shown in the following Table 4.

TABLE 4

| | Weak level | | | Moderate level | | | | Strong level | | |
|---|---|---|---|---|---|---|---|---|---|---|
| Laughter | 1 | 2 | 3 | 4 | 5 | 6 | 7 | 8 | 9 | 10 |
| Speaking | 0.5 | 1 | 1.5 | 2 | 2.5 | 3 | 3.5 | 4 | 4.5 | 5 |
| Voice | | | | | | | | | | |
| Exclamation | 2 | 4 | 6 | 8 | 10 | 12 | 14 | 16 | 18 | 20 |
| Scream | 1.5 | 3 | 4.5 | 6 | 7.5 | 9 | 10.5 | 12 | 13.5 | 15 |

In Tables 3 and 4, the weak level may be set to correspond to a sound of 30 dB or more and less than 50 dB, the moderate level may be set to correspond to a sound of 50 dB or more and less than 80 dB, and the strong level may be set to correspond to a sound of 80 dB or more. Here, a sound of less than 30 dB may be regarded as noise and ignored.

As described above, according to the present disclosure, a field atmosphere may be taken into account. In a real field, a surrounding atmosphere may be more largely affected by a sound than a facial expression or gesture of a person among reactions. Thus, the reaction level determiner 13 may set a reaction level for the sound to be higher than those for the other reactions.

Further, a person around a simulator may pay more attention to an exclamation than laughter or a speaking voice among the kinds of sound, and a scream may attract more attention to the simulator than an exclamation. Thus, in this example, the highest reaction level is assigned to the scream. However, this assignment is only for the purpose of illustration, and the highest reaction level may be assigned to an exclamation among the other sounds. Moreover, the reaction levels may be variously assigned. In addition, values and numbers of the reaction levels may be variously modified according to the kind and level of a sound.

Further, the reaction level determiner 130 may assign a reaction level with respect to different criteria by subdividing one kind of reaction in addition to assigning a reaction level according to a kind of a reaction or strength of the reaction. For example, in the case of an exclamation or a scream, a higher reaction level may be assigned to a more stimulating exclamation or scream than a less stimulating exclamation or scream.

Alternatively, the reaction level determiner 130 may detect a reaction determined by a simulation auxiliary device in addition to a reaction directly observable by others, and determine a reaction level thereof. For example, although a reaction such as a rise of blood pressure, a respiratory change, or the like is not directly observable by others, the reaction level determiner 130 may employ the simulation auxiliary device to sense such a reaction, and may expand the sensed reaction to a body reaction that may be converted to be visibly or audibly observable by others such that the reaction level is determined.

Further, the reaction level determiner 130 additionally detects a reaction of a person who has a positive effect (i.e., who make a positive reaction) on a field atmosphere among a plurality of spectators besides the participant, and additionally determines the reaction level of the detected reaction. Accordingly, the reaction level determiner 130 may determine the reaction level of a spectator as well as the participant.

The method of determining a reaction level performed by the reaction level determiner 130 may be broadly classified into three methods. Specifically, the reaction level determiner 130 may determine a reaction level by a first reaction level determining method of detecting a reaction of a participant and determining a reaction level thereof based on the detected reaction of the participant, a second reaction level determining method of determining a reaction level based on how great of an effect a reaction of a participant has on surrounding spectators, and a third reaction level determining method of detecting a reaction level based on a combination of the first reaction level determining method and the second reaction level determining method.

The first reaction level determining method detects a participant's own reaction, and determines a reaction level thereof in accordance with strength and frequency of the reaction. For example, the reaction level determiner 130 detects at least one of a sound being made, a change in voice loudness, a change in facial expression, and a change in gesture by the participant in a field, counts them during the detection, and determines reaction levels of the participant and spectators based on strength and frequency of the detected reaction.

In the first reaction level determining method, the reaction level determiner 130 may assign a higher reaction level when at least one of a sound being made, a change in voice loudness, a change in facial expression, and a change in gesture is increased. Here, the reaction level determiner 130 may determine a reaction level based on a facial expression, a gesture, and a sound corresponding to a positive emotion. For example, the facial expression corresponding to the positive emotions may include a smiling expression, a surprised expression, and the like. The gesture corresponding to the positive emotion may include clapping, giving a thumbs up, and the like. The sound corresponding to the positive emotion may include a scream (e.g., “yaa,” “ugh,” “ack,” and such sounds), an exclamation (e.g., “whoa,” “ah,” “wow,” “amazing,” and such sounds that a person makes when he or she is positively surprised), a speaking voice (e.g., normal talking), and the like. Of course, the facial expression, the gesture, and the sound may further include a variety of facial expressions, gestures, and sounds that may be made when a person is laughing, happy, and surprised in addition to those described above.

A facial expression or gesture among a sound being made, a change in voice loudness, a change in facial expression, and a change in gesture may not have a great effect on the field atmosphere even though strength thereof is high. Thus, the reaction level determiner 130 may set a reaction level of a sound to be higher than a reaction level of a facial expression or gesture. For example, the method of setting reaction levels differently according to a type of a reaction is similar to the method described with reference to Table 4. Alternatively, the reaction level determiner 130 may allow reaction levels of a facial expression, a gesture, and a sound to be within a similar range, but may give a higher weight to the sound when determining the reaction level.

Below, an example of a weighting method will be described. It will be assumed that the reaction level determiner 130 gives a reaction level of 1 to 10 according to a type of a reaction and an extent thereof. At this time, the reaction level determiner 130 may set weights to be different according to the type of the reaction, and, for example, may set a weight of 2 for a sound, a weight of 1 for a change in facial expression, and a weight of 1.5 for a change in gesture. Here, it will be further assumed that the reaction level determiner 130 determines each reaction level of both a first participant and a second participant as 50, the first participant has a reaction of only a facial expression, and the second participant has a reaction of only a sound. In this case, when the weight is reflected in the reaction levels, a final reaction level of the first participant is set to be 50, but a final reaction level of the second participant is changed to 100. Of course, the reaction levels and the weights are not limited to the foregoing example and may be variously changeable.

When it is assumed that the first participant makes a positive facial expression a first number of times during a preset period of time and the second participant makes a positive sound (e.g., an exclamation, a scream, or a speaking voice) the first number of times during the preset period of time, the reaction level determiner 130 may assign a higher reaction level to the second participant than the first participant. Accordingly, the reaction level determiner 130 reflects the differently set weights according to the type of reaction when calculating a reaction level, thereby finally determining the reaction levels for each of a participant and spectators. For example, the reaction level determiner 130 may determine the reaction level according to the criteria shown in Table 5 below.

TABLE 5

| Sum of reaction levels | Reaction level |
|---|---|
| ~99 | 1 |
| 100~199 | 2 |
| 200~299 | 3 |
| 300~399 | 4 |
| 400~499 | 5 |
| 500~599 | 6 |
| 600~699 | 7 |
| 700~799 | 8 |
| 800~899 | 9 |
| 900~ | 10 |

In Table 5, the left column shows the sum of reaction levels, and the right column shows the reaction level set according to the sum of reaction levels. Here, the number of reaction levels and the sum of reaction levels used for the criteria may be variously modifiable.

Further, when at least one among a sound being made, a change in voice loudness, a change in facial expression, and a change in gesture is detected but strength thereof is very low (i.e., the reaction is lower than a threshold set according to the type of reaction), the reaction level determiner 130 may not include the detected reaction in the reaction level. For example, the values corresponding to the weak levels in Tables 1 to 3 described above may not be reflected when summing the reaction levels. Of course, the threshold may be variously modifiable.

The reason why these factors are taken into account is because a very small reaction does little to improve a field atmosphere and one of the purposes of the present disclosure is to improve the field atmosphere. Thus, a final sum obtained by summing only reaction levels that attract the attention of others may be more effective in improving the field atmosphere.

Another one of the purposes of the present disclosure is to induce a surrounding person to participate in a simulation. In this regard, a reaction level of a simulation participant is more meaningful when it increases the interest of the surrounding person in the simulation participant. Thus, like the second reaction level determining method, which will be described later, considering an extent to which the surrounding person is affected may be important.

The second reaction level determining method refers to a method of determining a reaction level based on an extent to which a surrounding person is affected by a reaction of a participant. Specifically, in the second reaction level determining method, the reaction level determiner 130 determines an extent to which a surrounding spectator is affected by the reaction of the participant, and the number of times the reaction is made, calculates a reaction level according to the extent of the affect and the number of times the reaction is made, and determines a reaction level based on the calculated reaction level. The determination of the reaction level may be achieved by reflecting the preset criteria, as described above with reference to Table 5 on the calculated reaction level. In addition, similarly to the first reaction level determining method, the second reaction level determining method may assign a higher level to a reaction with an extent which affects a surrounding person more.

For example, the reaction level determiner 130 senses at least one among a sound being made, a change in voice loudness, and a change in facial expression of a surrounding spectator, and a change in the number of surrounding spectators, in accordance with a reaction made by a participant, and assign the reaction level to the participant based on the sensed results.

The third reaction level determining method refers to a combined method of the first reaction level determining method and the second reaction level determining method described above. That is, the third reaction level determining method determines a reaction level by considering both a reaction of a participant and an extent to which a surrounding environment is affected by the reaction of the participant. For example, when the reaction level is determined with regard to the participant, a reaction level of the participant him or herself and a spectator's reaction level are taken into account to determine the reaction level of the participant.

In other words, the reaction level determiner 130 may determine the reaction level of the participant by considering the reaction level of the spectator (or a reaction of the spectator). Here, the reaction level of the spectator may be determined by a first sum obtained by summing reaction levels of spectators; a second sum obtained by summing one or more of reaction level values of the entire group of spectators such as a change in the number of spectators or a change in voice loudness of the entire group of spectators; or a sum obtained by combining the first sum and the second sum, as described with the first to third reaction level determining methods. When the sum is determined, the reaction level determiner 130 reflects the criteria described with reference to Table 5 on the obtained sum to determine the reaction level. Since details regarding such a determination are given above, repetitive descriptions thereof will be omitted.

A reaction level of a simulation spectator may be determined through the same method as that used when determining the reaction level of the simulation participant. In this case, each of the reaction levels of the spectators may be summed, or a single reaction level such as voice loudness may be obtained from the entire group of spectators. Further, as another example of a single reaction level of the entire group of spectators, a change in the number of surrounding simulation spectators during the simulation may be considered.

Accordingly, the reaction level determiner 130 according to the first embodiment of the present disclosure looks for a person who has an effect on a field atmosphere through various methods and determines a reaction level in accordance with an extent to which a reaction of the person affects the field atmosphere.

In the above descriptions, the reaction level determiner 130 detects a reaction of a participant (or a spectator) during a simulation and determines a reaction level in accordance with the detected reaction. Here, a reaction detecting time which the reaction level determiner 130 uses to detect the reaction is not an entire period of the simulation, but one or more preset points of time at which a reaction of the participant is expected during the simulation. For example, the preset points of time at which a reaction of the participant is expected may include a point of time at which the simulator suddenly moves due to control of the participant on a program of the simulation, for example, when the simulator is expected to rapidly move in a straight line or rotate.

Of course, the reaction level determiner 130 may detect a reaction throughout the entire period of the simulation. However, when a reaction is detected not at the specific points of time but throughout the entire period, a corresponding load on a processor increases, and thus detecting efficiency decreases. On the other hand, when a reaction is detected only at the a preset point of time, there are advantages that methods of detecting a reaction and giving a reward are efficient, implementation is easy, a load on the processor is decreased, and comparison between participants is convenient. Besides, when a reaction is detected only at the preset points of time, it is possible to exclude an intentional reaction of a participant at a point of time at which a reaction is not expected, thereby eliminating resistance to a forced promotion and inducing voluntary participation of spectators around the simulator.

The reward determiner 140 is configured to give a reward according to the reaction level determined by the reaction level determiner 130. To this end, the reward determiner 140 checks a reaction level of the participant and compares the reaction level with a preset threshold reward level. Here, the reward determiner 140 may determine a participant whose reaction level is higher than the preset threshold reward level as a target to be rewarded. Further, the reward determiner 140 may give a reward preset for the reaction level to the participant determined to be the target to be rewarded. For example, when the participant is rewarded with points, the points to be given to the target to be rewarded may be varied depending on the reaction level, as shown in Table 6 below.

TABLE 6

| Reaction Level | Points |
|---|---|
| 1 | 50 |
| 2 | 100 |
| 3 | 150 |
| 4 | 200 |
| 5 | 250 |
| 6 | 300 |
| 7 | 350 |
| 8 | 400 |
| 9 | 450 |
| 10 | 500 |

In the example shown in Table 6, the reaction level is classified into 10 groups, and a difference of 50 is given between each of the groups of reaction levels such that a different reward is given depending on the reaction levels. However, this is only for the purpose of illustration, and the number of reaction level groups and the rewards to be given according to the reaction levels may be variously modifiable.

In such a reward process, when the participant determined to be rewarded is a member registered to a corresponding service, the participant is simply rewarded. On the other hand, when an unregistered participant is determined to be the target to be rewarded, it is difficult to reward the participant, and the kind of reward is very restricted even though the participant is rewarded. In this case, the reaction rewarding apparatus 100 according to the present disclosure may further include the membership manager 150 for inducing membership application and managing members.

The membership manager 150 is configured to generate a membership application screen when a storage (not shown) configured to store information about a plurality of members has no information about a person determined to be the target to be rewarded, and provides the membership application screen to the person determined to be the target to be rewarded. Here, the membership application screen may be output through an output section 50. When a large amount of information is required to apply for membership, the person is highly likely to resist applying for membership. Thus, the membership manager 150 may generate a membership application screen with minimum identifiers (e.g., a photo and a phone number) uniquely identifying the person. For example, the membership application screen may be generated with an information input area allowing a user to input his or her ID (or name) and phone number, which are sufficient to apply for membership. Of course, another piece of information such as an E-mail address, an image of an iris, an image of a fingerprint, and the like of a user may be selectively used to apply for membership. However, it is preferable for a phone number to be used to apply for membership instead of other things since the phone number is easily accessible to a user and input as information.

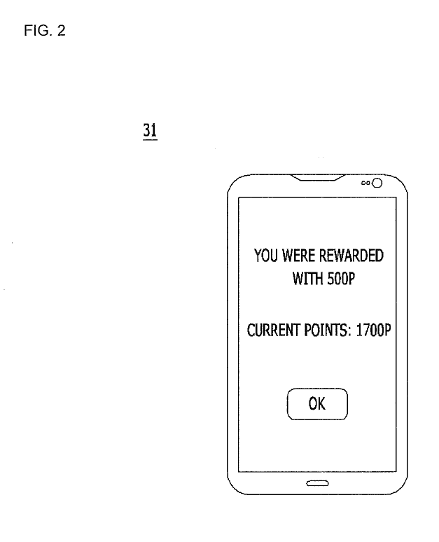

When the person becomes a member via his/her application, the reward determiner 140 gives a reward to the registered target to be rewarded. Further, when the reward determiner 140 completes giving the reward, the reward informer 170 generates a message for informing the person of the reward and transmits the message for informing of the result of the reward to a portable terminal of the rewarded person (see FIG. 2).

However, a participant (or a spectator) determined to be the target to be rewarded may not want to apply for membership. Although the participant (or the spectator) determined to be the target to be rewarded does not want to apply for membership, it is preferable for the target to be rewarded to induce him or her to have a positive experience with the simulator and increase a revisitation rate. Therefore, the reward determiner 140 may give a reward to the target to be rewarded even though the participant (or the spectator) does not apply for membership. As described above, there are various kinds of reward, such as a present (or a free gift), a voucher, a coupon (e.g., a free coupon or a discount coupon), a mileage point, and the like. However, control is performed such that a person for whom it is substantially difficult store or manage information in a database is rewarded with existing goods or the like (e.g., a voucher, a coupon, a free gift) and not with points, mileage points, or the like kept in a user account.

For example, to reward a person with existing goods, the reward determiner 140 gives at least one of a message written in text form and video information recorded by a camera to be immediately checked by a management staff member who is in the field so that the management staff member can reward the person with the goods. Of course, this is only for the purpose of illustration, and other various methods may be employed.

Like this, the reaction rewarding apparatus 100 according to the first embodiment of the present disclosure determines a person who has a positive effect on the field atmosphere and gives a participant (or a spectator) a reward converted according to a reaction level of the determined person. Thus, a rewarded customer contributes to an increase in the revisitation rate to use the reward, and this increase in the revisitation rate may have an effect on surrounding spectators. Further, the reaction rewarding apparatus 100 according to the first embodiment of the present disclosure replaces skilled personnel in a business field using the simulator, thereby improving the field atmosphere.

In the above descriptions, the reaction rewarding apparatus 100 according to the first embodiment of the present disclosure gives a reward to improve a field atmosphere. Alternatively, the reaction rewarding apparatus 100 according to the first embodiment of the present disclosure may also be utilized when evaluating a simulation implemented by a simulator on the basis of information about detected reactions, and providing basic data to be used when upgrading the simulation to increase immersion in the simulation or enhance effects thereof. Further, the basic data may be used in the future when a simulation service provider provides a variety of different services or artificial intelligent services, thereby diversifying the services.

Further, the reaction rewarding apparatus 100 according to the first embodiment of the present disclosure is installed at a specific place to be stationary and perform its functions. However, this is only for the purpose of illustration, and the reaction rewarding apparatus according to the present invention may be implemented in the form of a movable apparatus (e.g., an intelligent robot) with a driver. Further, some parts of the reaction rewarding apparatus may be provided in a movable apparatus while the other parts may be provided at a specific place. In addition, some parts may be provided in a remote place, as will be described later, and connected to the other parts via communication.

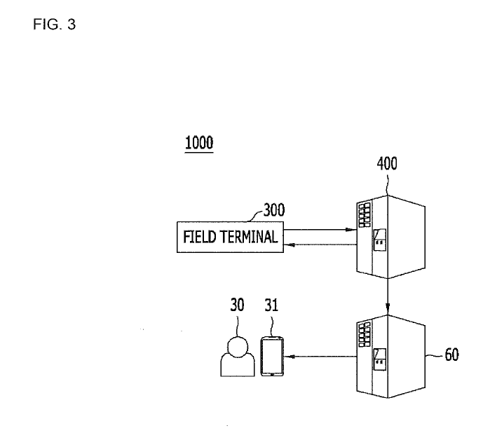

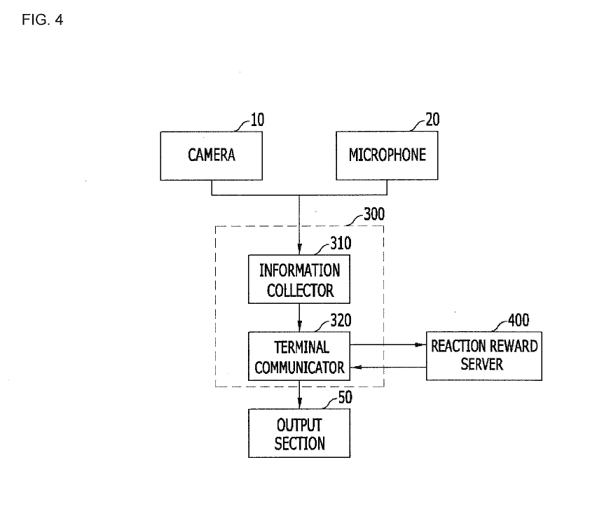

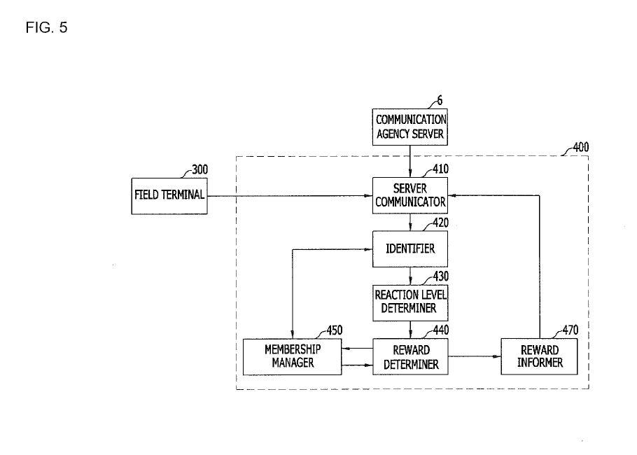

FIG. 3 is a conceptual view of a system 1000 for rewarding a simulator participant for a reaction according to a second embodiment of the present disclosure. FIG. 4 is a block diagram of a field terminal 300 according to the second embodiment of the present disclosure, and FIG. 5 is a block diagram of a reaction reward server 400 according to the second embodiment of the present disclosure.

In the system 1000 for rewarding a simulator participant for a reaction according to the second embodiment of the present disclosure, the reaction reward server described as the first embodiment of the present disclosure is divided into two apparatuses, and a simulation participant is rewarded for a reaction through communication between the two apparatuses. To this end, the reaction reward system 1000 according to the second embodiment of the present disclosure includes the field terminal 300 located at a field at which a simulator is installed, and the reaction reward server 400 operating as an external server.

The field terminal 300 collects information about a participant (or a spectator) in the field at which the simulator is installed and sends the collected information to the reaction reward server 400. In addition, the field terminal 300 may receive data about a membership application screen of a specific person (e.g., a target to be rewarded) generated through the reaction reward server 400 and output the received membership application screen through an output section 50. To perform these functions, the field terminal 300 according to the second embodiment of the present invention may include an information collector 310 and a terminal communicator 320 (refer to FIG. 5). Here, these elements are substantially equivalent to the information collector 110 described with reference to FIG. 1, except that the collected information is sent to the reaction reward server 400 through the terminal communicator 320, and thus repetitive descriptions thereof will be omitted.

The reaction reward server 400, as an external server, receives data (i.e., at least one of video information and audio information) from at least one field terminal 300, determines a reaction level of a participant (or a spectator) of the simulator on the basis of the received information, and rewards the participant (or the spectator) for a reaction according to the determined reaction level. Further, the reaction reward server 400 checks whether a person determined to be the target to be rewarded is registered as a member in the service, generates a membership application screen for inducing an unregistered person to apply for membership, and transmit the membership application screen to the field terminal 300. Further, the reaction reward server 400 may perform a process of giving a reward regardless of whether the person determined to be the target to be rewarded is registered as a member. Further, the reaction reward server 400 may generate a message for informing a result of being rewarded after giving the reward when the person to be rewarded is registered as a member, and transmits the message to the person through a mobile communication network server 60.

To perform the above functions, the reaction reward server 400 may further include a server communicator 410, an identifier 420, a reaction level determiner 430, a reward determiner 440, a membership manager 450, and a reward informer 470. Here, these elements have substantially the same functions as those included in the above apparatus according to the first embodiment of the present disclosure, except that pieces of information are received via communication with the field terminal 300. Thus, descriptions about the functions of the above elements will be omitted.

Here, the following effects are expected when the present invention is implemented in the form of a server and a client to perform the above functions.

First, when an element (i.e., the field terminal) for collecting information and an element (i.e., the reaction reward server) for substantive process are provided for the above functions, a load generated by the field terminal is considerably reduced. That is, from a simulation business operator's point of view, the business operator may rent or sell an apparatus for providing a service for rewarding a reaction to service providers in a simulation field, and the service providers may use the rented or purchased apparatus to provide the simulation service to a participant. Here, when it is assumed that the functions described with reference to FIG. 1 to FIG. 2 are implemented by a single apparatus, the apparatus needs a high-speed processor. The higher the performance of the processor, the higher the product costs. Therefore, the use of a high-speed processor is not good for both the business operator and the service provider.

On the other hand, when the apparatus rented to the business operator does not perform a plurality of processes but implements only functions of collecting information, transmitting information through a wired or wireless communication, and outputting a message, a relatively inexpensive processor is available, and thus an effect of considerably lowering production costs can be achieved. Such advantages may become more striking as the number of service providers increases.

Second, it is easy to update the sold or rented apparatuses. In the case of a reaction reward method according to the embodiments of the present disclosure, methods of determining a reaction level, the number of reaction levels, a weight, a reward amount, a kind of reward, and the like may be frequently updated. Of course, updates for debugging may be given in a program used to execute the methods. In this regard, when the above functions are implemented in a single apparatus rather than a server and a client, personnel may be needed for performing updates while moving from one place to another at which the single apparatus is installed, and it may also be difficult to immediately perform the update. On the other hand, in the case of a server and a client being used, a plurality of field terminals receive data corresponding to an update from the server simultaneously or according to conditions (e.g., after being booted up) in response to instructions from the server, and perform the update with the received data, and thus update processes are facilitated. In this case, the above personnel are not required, and thus advantages of preventing a waste of human resources and rapidly performing the update may be achieved.

Third, it is easy to collect basic data to be utilized when updating the simulation or various services in the future. As described above, the reaction rewarding apparatus and method according to the embodiment of the present disclosure are capable of providing the basic data to be utilized when updating the simulation or providing various services. In this case, when information collected from the plurality of field terminals is processed in the server, it is easy to collect the data since the server can collect a variety of information from the plurality of field terminals spread in various places (e.g., across a country)

However, this method requires the server to have high performance, and needs good communication conditions between the server and the client (i.e., the field terminal), management of the server, and the like. Accordingly, it is preferable for the apparatuses according to the first to second embodiments to be implemented according to a situation.

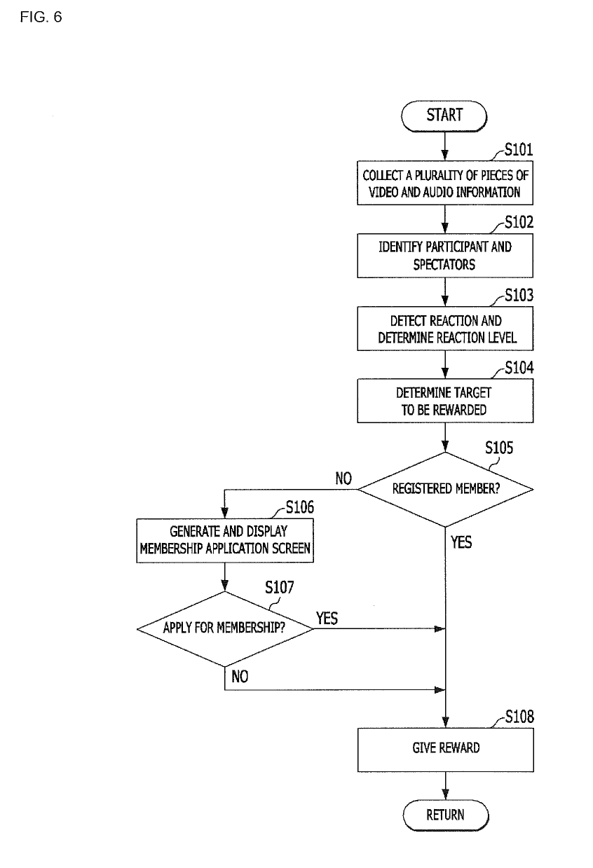

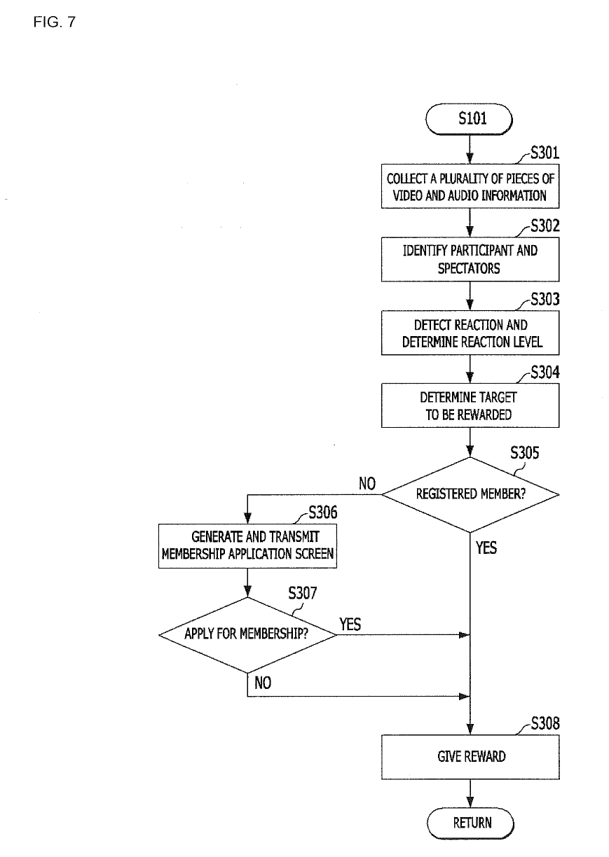

Below, the method of rewarding a simulation participant for reactions according to embodiments of the present disclosure will be described with reference to FIG. 6 to FIG. 7.

FIG. 6 is a flowchart of the method of rewarding a simulator participant for a reaction according to the first embodiment of the present disclosure. Specifically, FIG. 6 shows the flowchart of a method of determining reaction levels of a participant and spectators and giving rewards according to the reaction levels, which is performed by the reaction rewarding apparatus according to the first embodiment of the present disclosure. Below, repetitive descriptions will be omitted.

In operation S101, an information collector collects a plurality of pieces of video information and audio information. Specifically, operation S101 collects the video information from cameras provided inside and outside a simulator, and collects the audio information from microphones.

In operation S102, an identifier identifies a participant and spectators using the plurality of pieces of video information and audio information collected in operation S101. For example, operation S102 may identify the video information from the camera provided inside the simulator as that of the participant, and identify the video information corresponding to the outside of the simulator from the camera provided outside the simulator as that of the spectator. Further, operation S102 may further include determining whether the identified participant and spectators are registered as members.

In operation S103, a reaction level determiner detects reactions of the participant riding in the simulator and the spectators, and determines a reaction level of the participant. As described above, the reaction includes one of a sound being made, a change in voice loudness, a change in facial expression, and a change in gesture. To detect the reaction in operation S103, a preset face detecting algorithm (or an expression detecting algorithm) and a gesture detecting algorithm may be available. According to the present disclosure, these algorithms are not limited to specific algorithms. Further, operation S103 may be selected on the basis of an interaction with a simulation auxiliary device to measure a reaction such as a rise of blood pressure, a respiratory change, or the like not directly observable by others, and convert such a reaction into a body reaction that is visibly or audibly observable.

As described above, the determination of the reaction level in operation S103 may be achieved by a separate criterion according to a type of reaction. For example, in operation S103, a reaction level with regard to a sound being made among the reactions may be varied depending on a speaking voice, an exclamation, a scream, and the like, and a reaction level with regard to the change in gesture and the change in facial expression may be varied depending on a type of gesture and facial expression. Further, operation S103 may be carried out by assigning a higher reaction level to a more stimulating exclamation, assigning a higher reaction level to a higher sound level, and assigning a higher reaction level to a greater change in gesture and facial expression.

Further, operation S103 may be carried out by determining a reaction level of one among the types of reactions, or summing reaction levels with different weights according to the type of reaction with regard to the plurality of types of reactions, wherein the greatest weight may be set for sound among the types of reactions. operation S103 may be carried out by summing reaction levels detected at one or more preset points of time in the simulation, wherein the reactions level may be determined not according to the type of reaction but in consideration of the number of reaction times and the kinds of reactions.

Operation S103 may be carried out by summing only levels higher than or equal to thresholds defined for each type of reaction. As described above, this is to reward only a person who has an effect on a field atmosphere.

Further, the reaction level determining method performed in operation S103 is broadly divided into three methods. Among them, the first reaction level determining method determines a reaction level based on the participant's own reaction, the second reaction level determining method determines a reaction level based on an extent to which the reaction of the participant effects a surrounding person, and the third reaction level determining method refers to a proper combination method of the first reaction level determining method and the second reaction level determining method. Accordingly, operation S103 may determine the reaction level by detecting a reaction having an effect on the field atmosphere in consideration of the participant, the surrounding person, or a combination thereof.

When the reaction level of the participant is determined by the third reaction level determining method, operation S103 calculates a reaction level based on a first sum obtained by summing the reaction levels of the spectators; a second sum obtained by summing at least one reaction level value of the entire group of spectators such as a change in the number of spectators or a change in voice loudness of the entire group of spectators; or a sum obtained by combining the first sum and the second sum, and thus determines the reaction level based on the reaction. This was described above in detail, and thus a repetitive description thereof will be omitted.

Further, as described above, operation S103 may be performed at one or more preset points of time at which a reaction of the participant is expected during the simulation and not over the entire simulation.

In operation S104, the reward determiner determines a target to be rewarded. Specifically, operation S104 checks the reaction level of the participant, and compares the checked reaction level with a preset threshold reward level to determine the target to be rewarded. Operation S104 may determine a participant or spectator having the threshold reward level or higher as the target to be rewarded. Of course, in operation S104, there may even be a difference in the amount or extent of the reward given according to a reaction level thereof between participants having the threshold reward level or higher.

In operation S105, a membership manager determines whether the target to be rewarded determined in operation S104 is registered as a member. When it is determined that the target to be rewarded is registered as a member, the process processed to operation S108. Otherwise, the process proceeds to operation S106.

In operation S106, the membership manager generates and displays a membership application screen. For example, operation S106 may be carried out by inducing the target to be rewarded to input a phone number or the like. When this information is input, a membership number of the corresponding person is issued or a photo may be stored together with the phone number or the like.

In operation S107, the membership manager determines whether the target to be rewarded applies for membership. When it is determined that the target to be rewarded signs up for membership to get the reward, the process proceeds to operation S108. Even when the target to be rewarded does not sign up for membership, the process may proceed to operation S108.

In operation S108, a reward determiner gives the reward. Further, the reward may include at least one among a point, a free gift, a voucher, a free coupon, a discount coupon, and a mileage point. Here, when the target to be rewarded is an existing or new member, there are no limits to the kind of reward to be given. On the other hand, when the target to be rewarded is not a member, operation S108 may be carried out by giving existing goods (e.g., a voucher, a coupon, a free gift, and the like) to the target to be rewarded. That is, the target to be rewarded refers to a person who has a great effect on the field atmosphere, and operation S108 gives the reward to the target to be rewarded regardless of whether the target to be rewarded is a member to increase a revisitation rate of the target to be rewarded.

FIG. 7 is a flowchart of a method of operating a reaction reward server of a simulator participant according to the second embodiment of the present disclosure. As described above, the second embodiment of the present disclosure shows a method of a case in which the reaction rewarding apparatus is divided into two apparatuses, that is, the field terminal and the reaction reward server. Here, the field terminal performs only the functions of collecting video information and audio information, sending the collected information to the reaction reward server, and generating an output under control of the reaction reward server, and therefore the operations of the reaction reward server will be mainly described. Further, repetitive descriptions will be omitted.

In operation S301, a server communicator receives a plurality of pieces of video information and audio information from a field terminal. As mentioned above, a camera and a microphone are installed inside or outside a simulator installed in a field, and the field terminal collects the plurality of pieces of video information and audio information through the camera and the microphone. When the collection is completed, the video information and the audio information collected in the field terminal are sent to a reaction reward server.

In operation S302, an identifier identifies a participant and a spectator using the plurality of pieces of video information and audio information collected in operation S301.

In operation S303, a reaction level determiner detects reactions of the participant riding in the simulator (or spectators), and determines a reaction level of the participant (or the spectators). In operation S304, a reward determiner determines a target to be rewarded. Operations S303 and S304 are substantially equivalent to operation S103 and operation S104 described with reference to FIG. 6, and repetitive descriptions thereof will be omitted.

In operation S305, a membership manager determines whether the target to be rewarded determined in operation S304 is registered as a member. When it is determined that the target to be rewarded is a registered member, the process proceeds to operation S308. Otherwise, the process proceeds to operation S306.

Operations S306 and S307 induce the target to be rewarded to apply for membership to be rewarded. Specifically, in operation S306, the membership manager generates a membership application screen and transmits it to the field terminal. Thus, the field terminal outputs the received membership application screen through an output section to induce the corresponding target to be rewarded to sign up for membership.

In operation S307, the membership manager determines whether the target to be rewarded signs up for membership. When it is determined that the target to be rewarded signs up for membership, the process proceeds to operation S308. Even when the target to be rewarded does not sign up for membership, the process may proceed to operation S308.

In operation S308, a reward determiner gives a reward. As described above, the reward may be given regardless of whether the target to be rewarded is registered as a member. However, the kind of reward may be varied depending on whether the target to be rewarded is registered as a member.

The principles of the present disclosure may be implemented through a combination of hardware and software. Further, the software may be realized as an application program practically achieved in a program storage. The application program is uploaded to a machine including any proper architecture and executed by the machine. Preferably, the machine may be implemented as a computer platform having one or more hardware components such as a CPU, a computer processor, a random access memory (RAM), and an input/output (I/O) interface. Further, the computer platform may include an operating system and a microinstruction code. Various processes and functions described herein may be a part of the microinstruction code, a part of an application program, or a combination thereof, and may be executed by various processing devices including the CPU. In addition, peripheral devices such as an additional data storage, a printer, and the like may be connected to the computer platform.

Since system components and methods shown in the accompanying drawings are partially and preferably realized as software, it should be understood that a practical connection between the system components or processing function blocks may be varied depending on methods of programming the principles of the present disclosure. It should be further appreciated that those skilled in the art can take embodiments or features similar to the principles of the present disclosure into account.

In a method and apparatus for rewarding a simulation participant for a reaction according to one embodiment of the present disclosure, a reaction of a participant is sensed, and a person who makes a reaction to enhance a field atmosphere is rewarded according to the sensed results. Such a reward (e.g., a point, a coupon for one or more use, a voucher, a mileage point, and the like) may increase a field revisitation rate of the simulation participant. The increase in the revisitation rate increases the number of people who have good reactions, thereby having a positive effect on the field atmosphere. That is, a large reaction (or an exaggerated reaction) of the participant stimulates surrounding spectators' curiosity to induce them to use the simulator.

According to one embodiment, more people are induced to take part in a simulation, and thus a simulation operator's income is increased, and it is also possible to evaluate the simulation and provide basic data for upgrading the simulation to increase immersion in the simulation or improve effects thereof without limitation. Further, data obtained according to the embodiment of the present disclosure is utilizable when a simulation service provider provides various other services or a service using artificial intelligence, thereby diversifying services.

In a method and apparatus for rewarding a simulation participant for a reaction according to one embodiment of the present disclosure, it is possible to enhance a field atmosphere without skilled personnel, and a business operator can effectively reduce costs for managing a business using a simulator.

Although exemplary embodiments have been described with reference to the accompanying drawings, it should be appreciated that the principles of the present disclosure are not limited to these embodiments, and various changes and modifications can be made by those skilled in the art without departing from the spirit or scope of the present disclosure. Thus, the present disclosure is intended to cover all such modifications provided they come within the scope of the appended claims and their equivalents.

Specific terms are used herein only for the purpose of illustration and do not limit the meaning or the scope of the present disclosure defined in the appended claims. Therefore, it should be understood by a person having ordinary skill in the art that various modified and equivalent embodiments can made from the present disclosure. Accordingly, the technical scope of the present disclosure should be determined by the appended claims.

What is claimed is:

1. A method of rewarding a simulation participant taking part in a simulation implemented by a simulator for a reaction, the method comprising:
collecting at least one of video information and audio information of a participant while the participant takes part in a simulation from at least one of a camera and a microphone;
detecting one or more reactions of the participant from the collected at least one of the video information and the audio information;
determining a reaction level of the detected reaction; and
giving a reward for the reaction to the participant when the determined reaction level is a certain value or more.

2. The method according to claim 1, wherein the reaction comprises at least one of a sound being made, a change in voice loudness, a change in facial expression, and a change in gesture of the participant.

3. The method according to claim 1, wherein the detecting of the one or more reactions is performed at one or more preset points of time at which the reaction of the participant is expected during the simulation.

4. The method according to claim 1, wherein the determining of the reaction level comprises determining the reaction level based on different criteria according to a type of each of the reactions.

5. The method according to claim 4, wherein the determining of the reaction level is performed by determining a reaction level value of one among the types of reactions or summing reaction level values with different weights according to the type of the reaction with regard to the plurality of types of reactions.

6. The method according to claim 5, wherein a highest weight is given to a change in voice loudness of the participant among the types of reactions.

7. The method according to claim 5, wherein the determining of the reaction level is performed by summing reaction level values detected at one or more preset points of time in the simulation.

8. The method according to claim 4, wherein the determining of the reaction level is performed by summing only reaction level values higher than or equal to a threshold set for the type of each of the reactions.

9. The method according to claim 1, wherein the determining of the reaction level is performed in consideration of reaction levels of one or more spectators.

10. The method according to claim 9, wherein the reaction level of the spectator is determined by a first sum obtained by summing reaction levels of the spectators; a second sum obtained by summing at least one reaction level value of an entire group of spectators such as a change in the number of spectators or a change in voice loudness of the entire group of spectators; or a sum obtained by combining the first sum and the second sum.

11. The method according to claim 1, wherein the reward comprises at least one among a point, a free gift, a voucher, a free coupon, a discount coupon, and a mileage point.

12. The method according to claim 1, wherein the giving of the reward comprises giving the reward for the reaction differentially for each reaction level.

13. The method according to claim 1, further comprising identifying the simulation participant.

14. The method according to claim 13, further comprising:
checking whether a participant whose determined reaction level is the certain value or more is registered as a member; and
generating a membership application screen to induce the participant to apply for membership when the participant is not registered as the member,
wherein the membership application screen comprises an information input area for receiving an ID and phone number of the participant.

15. The method according to claim 1, wherein:
the collecting is performed in a field terminal at a field at which the simulator is located;
the detecting, the determining of the level, and the giving of the reward are performed in a server; and
the field terminal and the server are configured to communicate with each other.

16. An apparatus for rewarding a simulation participant taking part in a simulation implemented by a simulator for a reaction, the apparatus comprising:
an information collector configured to collect at least one of video information and audio information of a participant while the participant takes part in a simulation by using at least one of a camera and a microphone;
a reaction level determiner configured to detect at least one reaction of the participant from the collected at least one of the video information and the audio information, and determine a reaction level of the detected reaction; and
a reward determiner configured to give a reward for the reaction to the participant when the determined reaction level is a certain value or more,
wherein the apparatus is configured to perform operations of the method according to claim 1.

17. The apparatus according to claim 16, further comprising an identifier configured to identify the simulation participant.

18. The apparatus according to claim 16, further comprising a membership manager configured to check whether a participant whose determined reaction level is the certain value or higher is registered as a member, and generate a membership application screen to induce the participant to apply for membership when the participant is not registered as the member, wherein the membership application screen comprises an information input area for receiving an ID and phone number of the participant.

19. The apparatus according to claim 16, wherein the apparatus for rewarding the simulation participant for the reaction comprises an intelligent robot, and the intelligent robot receives information from a camera or a microphone located inside or around the simulator or from a camera or a microphone mounted to one side of the intelligent robot.

20. A server for rewarding a simulation participant taking part in a simulation implemented by a simulator for a reaction, the server comprising:
a server communicator configured to receive at least one of video information and audio information of a participant while the participant takes part in a simulation from a field terminal at a field at which the simulator is located;
a reaction level determiner configured to detect at least one reaction of the participant from the received at least one of the video information and the audio information, and determine a reaction level of the detected reaction; and
a reward determiner configured to give a reward for the reaction to the participant when the determined reaction level is a certain value or more.

21. A method of rewarding a simulation participant taking part in a simulation implemented by a simulator for a reaction, wherein
the method is performed in a reaction reward server, and
the method comprises:
receiving at least one of video information and audio information of a participant while the participant takes part in a simulation from a field terminal at a field at which the simulator is located;
detecting at least one reaction of the participant from the received at least one of the video information and the audio information;
determining a reaction level of the detected reaction; and
giving a reward for the reaction to the participant when the determined reaction level is a certain value or more.
